(19) United States
(12) Patent Application Publication
(10) Pub. No.: US 2018/0233057 A1
(43) Pub. Date: Aug. 16, 2018

(54) PROACTIVE CONTENT RECOMMENDATION IN TEACHING SPACE

(71) Applicant: MICROSOFT TECHNOLOGY LICENSING, LLC, Redmond, WA (US)

(72) Inventors: Daniel SITTON, Tel Aviv (IL); Dror KREMER, Tel Aviv (IL); Shay BEN-ELAZAR, Haifa (IL); Shay SLOBODKIN, Haifa (IL); Oded VAINAS, PETACH TIKVA (IL); Yehuda Arkin ADAR, Haifa (IL); Ran GILAD-BACHRACH, Bellevue, WA (US); Ze'ev MAOR, Haifa (IL)

(73) Assignee: MICROSOFT TECHNOLOGY LICENSING, LLC, Redmond, WA (US)

(21) Appl. No.: 15/598,910

(22) Filed: May 18, 2017

Related U.S. Application Data
(60) Provisional application No. 62/458,514, filed on Feb. 13, 2017.

(51) Int. Cl. G09B 5/06; G09B 5/08; G09B 7/08; G06Q 50/20; G06F 17/30

(52) U.S. Cl. CPC G09B 5/06; G09B 5/08; G06F 17/3056; G06Q 50/20; G09B 7/08

(57) ABSTRACT

A modern, personalized, adaptive learning experience may be enabled for distinct groups of students. Content entered in a notebook application or similar platform may be analyzed. Content from a learning object repository may then be selected to be suggested based on comparison with the entered content. A style may also be determined based on one or more of a common attribute of a group of teachers, a common attribute of a group of students, or a rule of an organization. The selected content to be suggested may be automatically customized to conform to the style and a lesson plan, and the customized content may be provided to a client application or another service to be displayed in conformance with the lesson plan to students supporting teachers by freeing teachers' time through optimization of the learning process, creation of easy and simple to use experiences, and actionable analytics and proactive alerts.

### CROSS-REFERENCE TO RELATED APPLICATIONS

This Application claims the benefit under 35 U.S.C. § 119(e) of U.S. Provisional Patent Application Ser. No. 62/458,514 filed on Feb. 13, 2017, The disclosure of the U.S. Provisional Patent Application is hereby incorporated by reference in its entirety.

### BACKGROUND

Teaching has not experienced a major infrastructural change in many hundreds of years. Since the first books were used in a classroom environment, teaching has generally followed the path of a teacher reciting sections of a book, adding some information verbally or using other material, and students following the provided lesson material. Thus, teachers may have to spend extra time and energy to supplement textbooks. Still, the end product is typically not customized for individual students. Given that education science has proven each individual has unique learning abilities and patterns, the textbook-based traditional learning approach is not optimal for the individuals.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to proactive content recommendation in teaching space. In some examples, content entered in a notebook application or similar platform may be analyzed. Content from a learning object repository may be selected to be suggested based on comparison with the entered content. A style may also be determined based on one or more of a common attribute of a group of teachers, a common attribute of a group of students, or a rule of an organization. The selected content to be suggested may be automatically customized to conform to the style and a lesson plan, and the customized content may be provided to a client application or another service to be displayed in conformance with the lesson plan to students.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A and 1B include display diagrams illustrating example network environments where a system to provide a cloud based service for proactive content recommendation in teaching space may be implemented;

FIGS. 2A and 2B illustrate conceptually teaching paradigms according to traditional approaches and according to example embodiments;

FIG. 3 illustrates main blocks of an example process for proactive content recommendation in teaching space, arranged in accordance with at least some embodiments described herein;

FIG. 4 illustrates conceptually interactions between core elements of an adaptive and personalized learning system employing proactive content recommendation in teaching space according to some embodiments;

FIG. 5 illustrates a flow of actions in an adaptive and personalized learning system employing proactive content recommendation in teaching space according to some embodiments;

FIG. 6 illustrates conceptually an example system for proactive content recommendation in teaching space and actions associated with the flow of operations according to some embodiments;

FIG. 7 is an example networked environment, arranged in accordance with at least some embodiments described herein;

FIG. 8 illustrates a computing device, which may be configured to provide proactive content recommendation in teaching space, arranged in accordance with at least some embodiments described herein; and

FIG. 9 illustrates a logic flow diagram for an example process to provide proactive content recommendation in teaching space, arranged in accordance with at least some embodiments described herein.

### DETAILED DESCRIPTION

Briefly stated, a modern, personalized and adaptive learning experience may be enabled for distinct groups of students. Content entered in a notebook application or similar platform may be analyzed. Content from a learning object repository may then be selected to be suggested based on comparison with the entered content. A style may also be determined based on one or more of a common attribute of a group of teachers, a common attribute of a group of students, or a rule of an organization. Among other things, common attributes may include preferences. The selected content to be suggested may be automatically customized to conform to the style and a lesson plan, and the customized content may be provided to a client application or another service to be displayed in conformance with the lesson plan to students supporting the teachers by freeing teachers' time through optimization of the learning process, creation of easy and simple to use experiences, and actionable analytics and proactive alerts.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to provide proactive content recommendation in teaching space. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example embodiments may be found in the following description.

The technical advantages of providing proactive content recommendation in teaching space may include, among others, improved performance, reduced processing and network bandwidth usage, and improved user interaction by providing suitable content to supplement a lesson in a customized fashion and by incentivizing the interactions through individualization.

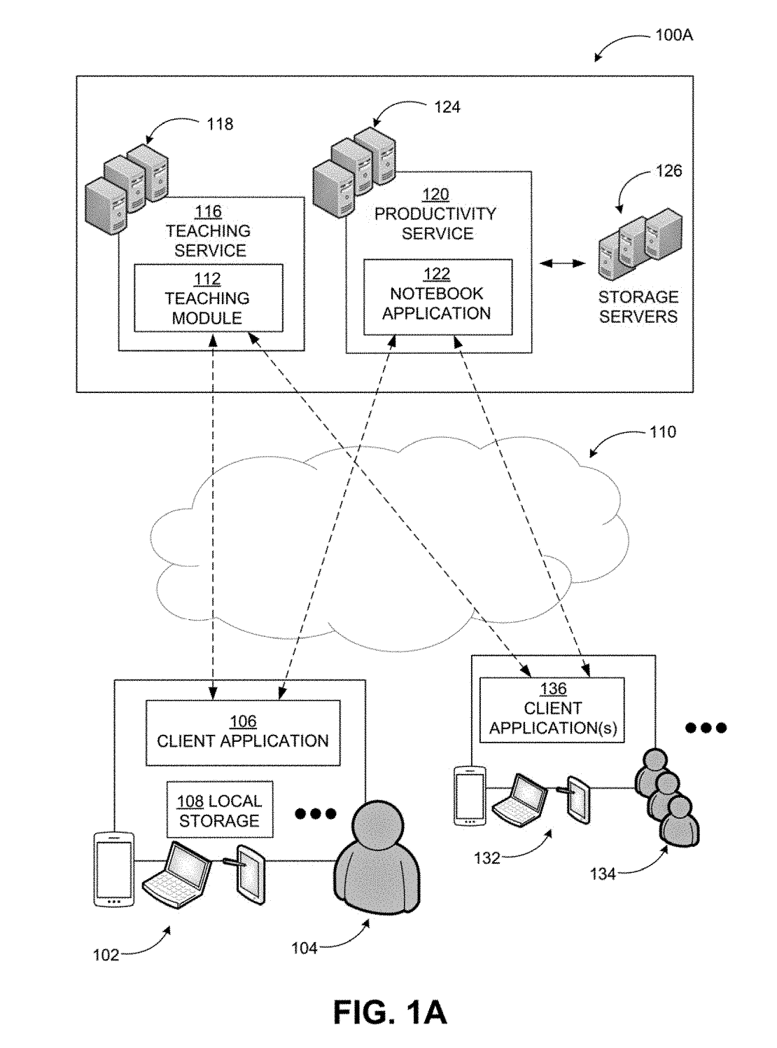

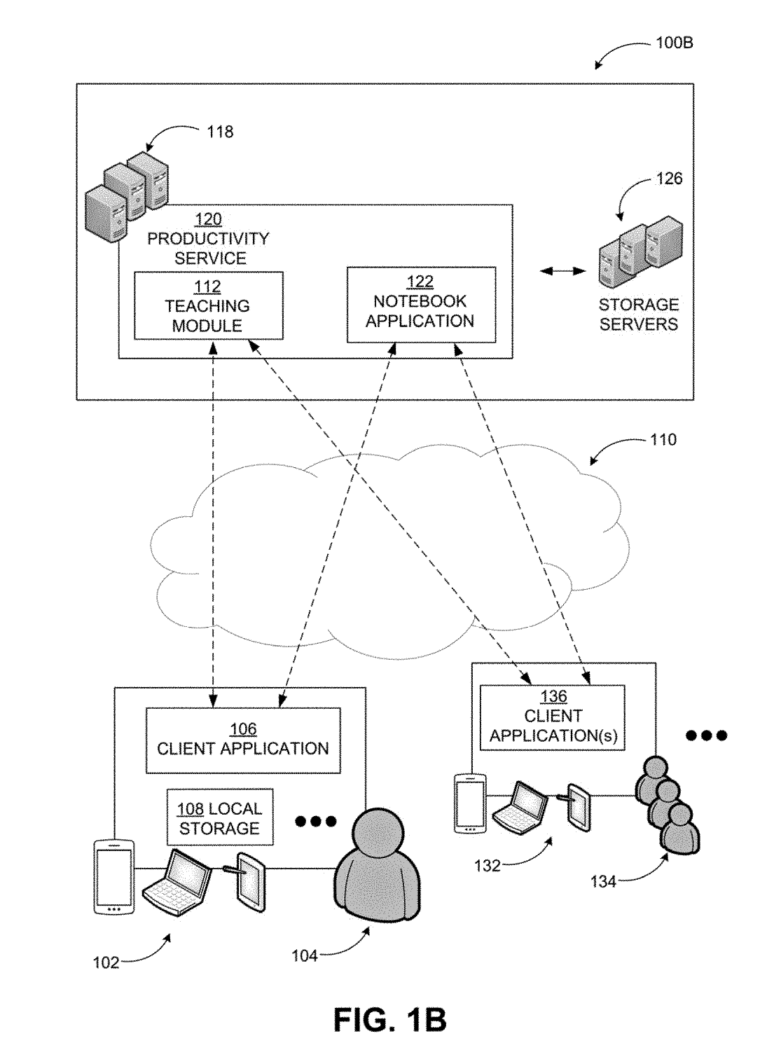

FIGS. 1A and 1B include display diagrams illustrating example network environments where a system to provide a cloud based service for proactive content recommendation in teaching space may be implemented.

As illustrated in diagram 100A, an example system may include a datacenter 114 hosting a productivity service 120 configured to, among other things, provide productivity services such as word processing, spreadsheets, presentations, calendar applications, etc. The datacenter may also host a teaching service 116, which may provide teaching services through a teaching module 112 such as teaching content, evaluations, etc. Both services may work in conjunction with cloud storage managed by storage servers 126, for example. The productivity service 120 and the teaching service 116 are examples of hosted services that allow users to access their services through client applications such as client applications 106 or 136 executed on one or more client devices 102 or 132.

The productivity service 120 may provide, for example, a notebook application 122, which may manage and process lesson materials for a teacher 104, who may access the services through local client application 106. Teaching content may be stored at the storage servers 126 or locally at local storage 108. In some embodiments, the teaching module 112 of the teaching service 116 may detect an entry for a lesson by the teacher 104 and determine content to be suggested for the lesson from a learning object repository based on analysis and comparison of the entry to available content at the repository. The teaching module 112 may also combine suggested content into a lesson presentation based on an analysis of teacher and student attributes, preferences, as well as other factors (e.g., general or school standards), and present customized lessons to students 134 through client applications 136 executed on their computing devices 132.

The analysis of teacher and student attributes, preferences, as well as other factors may be included in determining a style for the content to be incorporated into the lesson plan based on common attributes of teachers and/or students. Common attributes of groups of teachers may include a content selection preference, a formatting preference (e.g., preference of science teachers at a school), a content structure preference (e.g., preference of presenters in a corporate human resources department), and a presentation preference (e.g., flow, audio/text/video, color schemes, graphics usage, etc.) to name a few examples. Common attributes of groups of students may include a learning ability/disability, an interest in a particular content or a content structure, a formatting preference, and a presentation preference, for example. The common attributes may be obtained/retrieved from a data store, usage history, surveys, and/or similar groups.

The productivity service 120 and the teaching service 116 are examples of hosted services. Other examples may include communication services, scheduling services, online conferencing services, collaboration services, and comparable ones. As described herein, the productivity service 120, the teaching service 116 and/or the teaching module 112, the notebook application 122 may be implemented as software, hardware, or combinations thereof.

In some embodiments, the productivity service 120 or the teaching service 116 may be configured to interoperate with the client applications 106 and 136 through the client devices 102 and 132 over one or more networks, such as network 110. For example, the client applications 106 or 136 may be a word processing application, a presentation application, a notebook application, or a spreadsheet application in conjunction with the productivity service 120. The client devices 102 and 132 may include a desktop computer, a laptop computer, a tablet computer, a vehicle-mount computer, a smart phone, or a wearable computing device, among other similar devices.

Diagram 100B shows a different configuration of the system, where both of the teaching module 112 and the notebook application 122 may be part of the same service such as productivity service 120. Other configurations with additional or fewer components and hierarchies may also be implemented.

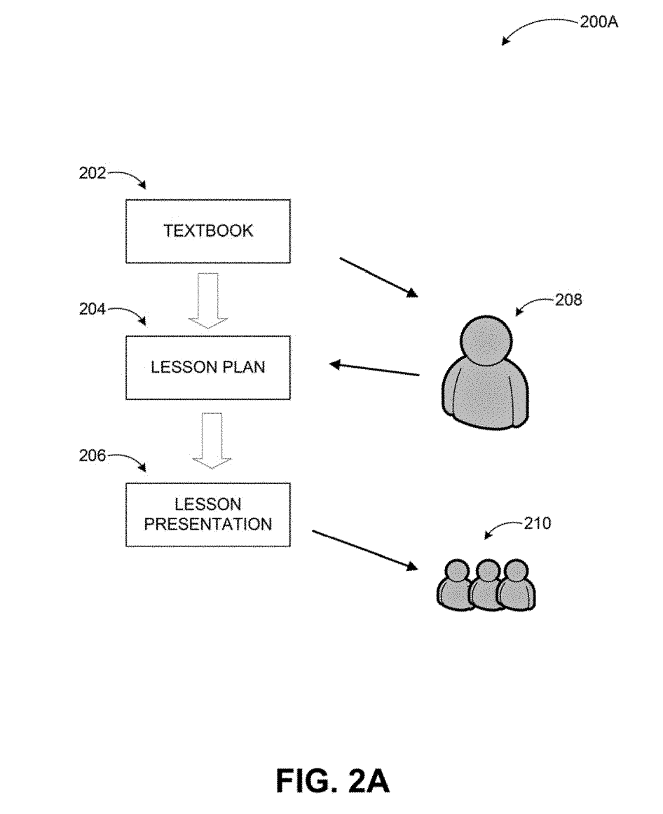

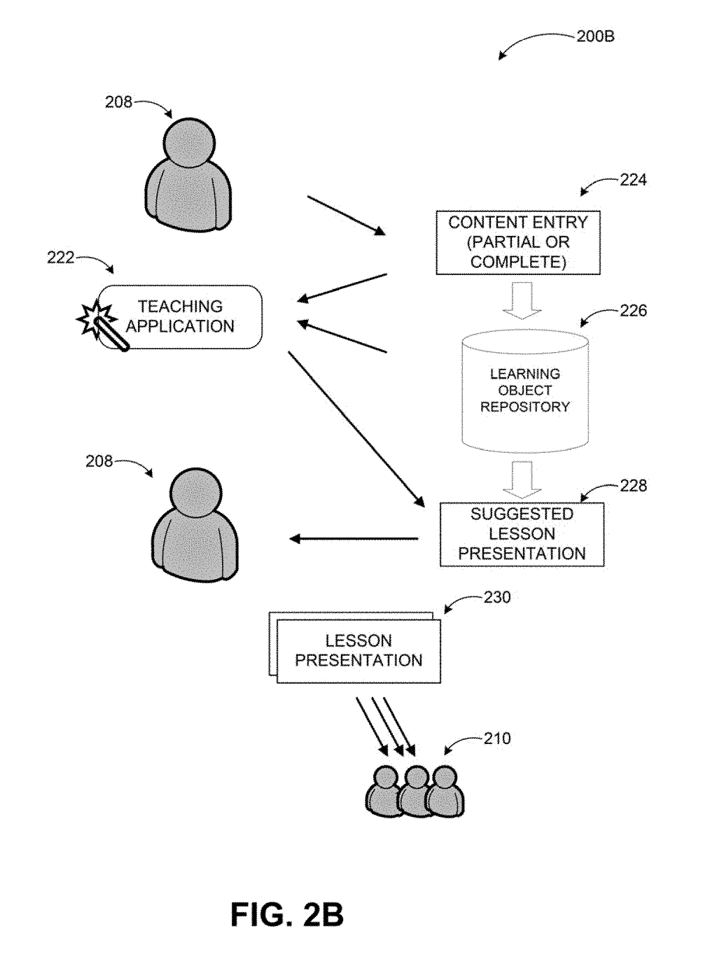

FIGS. 2A and 2B illustrate conceptually teaching paradigms according to traditional approaches and according to example embodiments.

Diagram 200A in FIG. 2A shows a traditional teaching approach, where a textbook 202 drives the lesson plan 204 managed by a teacher 208. For example, the teacher 208 may select certain sections from the textbook 202 to teach or use some supplemental materials in creating the lesson presentation 206 to students 210. However, any customization by the teacher 208 is typically manual and not customized for individual students. Thus, traditional teaching approaches may be rigid, time consuming to adjust, and not customizable for individual student needs.

Diagram 2008 in FIG. 2B shows an example lesson presentation according to some embodiments. A teaching application 222 or similar program may automatically detect partial or complete content entry 224 into a teaching space by the teacher 208 (and/or students 210) and analyze the detected content entry to determine content to be suggested from a learning object repository 226. The suggested content may be manually incorporated into a lesson presentation 230 by the teacher or the lesson presentation 230 may be automatically suggested to the teacher 208 based on a combination of suggested content taking teacher, student, lesson attributes and other factors.

As discussed above, content in a teaching data container may be analyzed upon detecting entry of the content in the teaching data container. For example, the teaching data container may be a notebook of a notebook application that stores and manages content of various types such as documents, audio content, video content, ink entries, and many more. Thus, the detected entry of the content in the notebook may be ink entry by a teacher or pasted content from another source. A first set of feature vectors may be generated based on the analysis. The analysis may include a number of content analyses such as optical character recognition of images, text conversion of ink entries, speech-to-text conversion of audio content, and comparable ones. The analysis may further include any metadata associated with the content as well as any users associated with the teaching data container. For example, attributes associated with the teacher, students, a class, or other teachers teaching similar classes may be used to supplement and/or filter analysis results.

The first set of feature vectors may be compared to a second set of feature vectors associated with content from a learning object repository. The content in the learning object repository may include a wide range of content including, but not limited to documents, audio objects, video objects, interactive material, and comparable ones. The second set of feature vectors may be generated from the content in the learning object repository or received as generated feature vectors. Content to be suggested from the learning object repository may be determined based on the comparison and presented in conformance with a lesson plan. In presenting the suggested content a spectrum of options may be employed. For example, the suggested content may be provided as a simple list (or with previews) for the teacher and/or students to manually incorporate to the lesson materials.

In another example, the style may be learned from direct input or analysis of teacher's (or a group of teachers') history and the suggested content may be combined according to the style. Other teachers' styles, default rules of a school or similar organization may also be used to adjust the style. In further examples, individual or groups of students' learning abilities/styles may be determined and the suggested content may be combined in an individually customized manner to fit each student's individual learning abilities/styles.

In further examples, organization rules may preempt or supersede common attribute (teacher and/or student groups) based style selection. The lesson plan may be strictly a timeline definition or may add more rules to the common attribute and/or organization rules based styles.

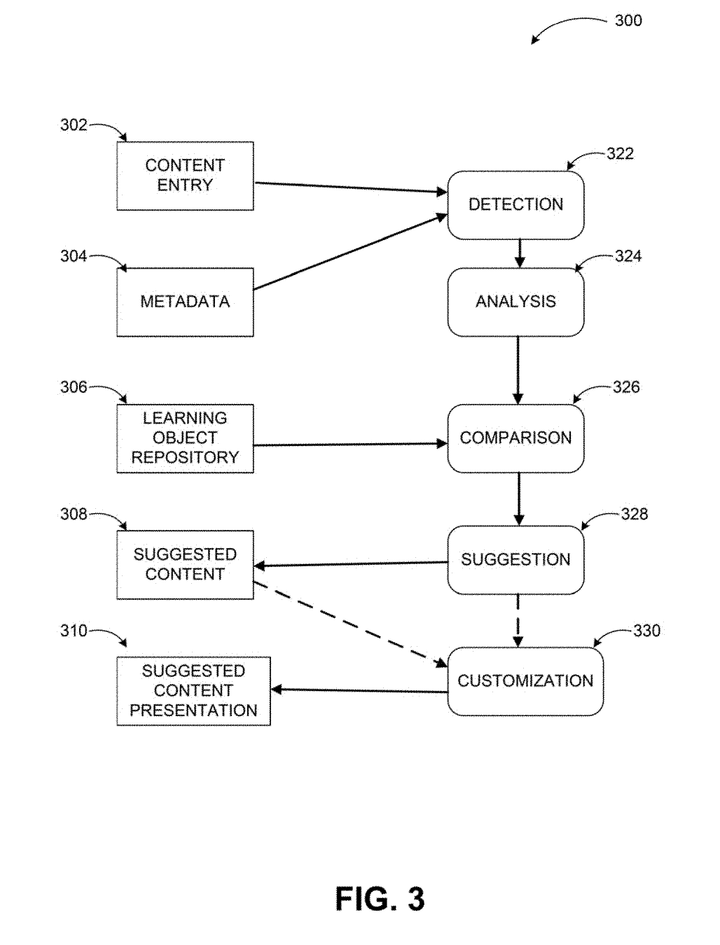

FIG. 3 illustrates main blocks of an example process for proactive content recommendation in teaching space, arranged in accordance with at least some embodiments described herein.

As shown in diagram 300, proactive content recommendation in teaching space may begin with detection 322 of content entry 302 into a teaching container such as a notebook, a smart whiteboard, a word processing document, or any other collaborative environment. Metadata 304 associated with the entered content such as who entered, if the content includes pre-packaged materials (e.g., videos, copied text, etc.), and comparable information may also be detected. The entered content may be analyzed 324 considering the metadata in order to match the entered content to content available from a learning object repository 306. For example, feature vectors may be generated from the entered content and compared 326 to feature vector of content available from the learning object repository 306. Based on the comparison 326, a suggestion process 328 may yield suggested content 308 to be incorporated into a presentation or lesson plan. The suggested content 308 may be customized 330 based a style derived from common attributes of teacher and/or student groups, individual preferences, organization rules, and standards. The customized content may then be manually or automatically incorporated into the lesson plan as suggested content presentation 310. The customized content may be provided as part of the same notebook into which the original content was entered or the customized content may be provided as part of a different document (e.g., a presentation, a word processing document, a video, etc.).

According to some embodiments, similarity analysis may be performed to determine suggested content from the repository. For example, feature vectors may be determined based on optical character recognition or other analysis of entered content (by teacher or students). Feature vectors of available content from the repository may be received from a third party source or generated by analyzing such content similarly. Then, the two sets of vectors may be compared and content represented by vectors that exceed a similarity threshold to the vectors of the entered content may be selected for suggestion.

Teacher, student, class attributes, and other suitable factors may be used to supplement the analysis of filter results. Suggested content may be presented for simple selection and manual incorporation into lesson presentation or combined and provided as partial or complete lesson presentation. The combination and customization of the lesson presentation may be based on teacher and student attributes and customized for each recipient.

The feature vector sets associated with the data entry (e.g., by the teacher or students) and content from the repository may also be used as an input to classification and prediction algorithms for recommending content, and be compared to each other in some examples. Such algorithms performing vector comparison or classification/prediction may be adjusted based on student's or teacher's usage information.

The features may be derived not only in isolation from either teacher/student properties or content properties, but also from both of the properties simultaneously. In an example of simultaneous feature generation, a student may write a short paragraph describing her/his interests and a feature may be generated that counts how many words in this paragraph appear in the proposed content. In contrast, a feature set may be generated from the words in the student's paragraph and several other feature sets may be generated from available content (e.g., videos, textual materials, etc.) in an isolated feature generation example. The feature set representing the student's paragraph may then be compared to the feature sets of the available content to determine suitable content to be suggested to the student.

The feature sets may not only be dynamic (i.e., based on current input), but may also be based on the teaching environment. Information (e.g., attributes and properties) associated with a class (or school) where the lesson is to be presented, participants (teacher, students), and comparable factors may be available from a variety of sources. For example, a productivity service may contain schedule, past collaboration, created documents, searches, and similar information associated with a teacher. Student performance and preferences may also be available from same or other sources. Even a notebook used for the class may include content and other information that may assist in focusing and filtering the analysis and comparison such that content suggestion is more accurate and combination of content for automatic lesson presentation is optimized for the recipients (teacher and students).

The information used to focus and filter the analysis and comparison may be generally referred to as context. Thus, contextual features may be added as the context may not only help increase an efficiency of the system, but also have an effect on the learning. For example, for presenting a lesson in class, it may be more suitable to recommend reading material, but for a lesson to be presented at home, video content may be more suitable.

Embodiments may be implemented in teaching environments of K-12, undergraduate, graduate, and post-graduate levels, but are not limited to those. Proactive content recommendation in teaching space may be implemented in a formal or informal teaching environment.

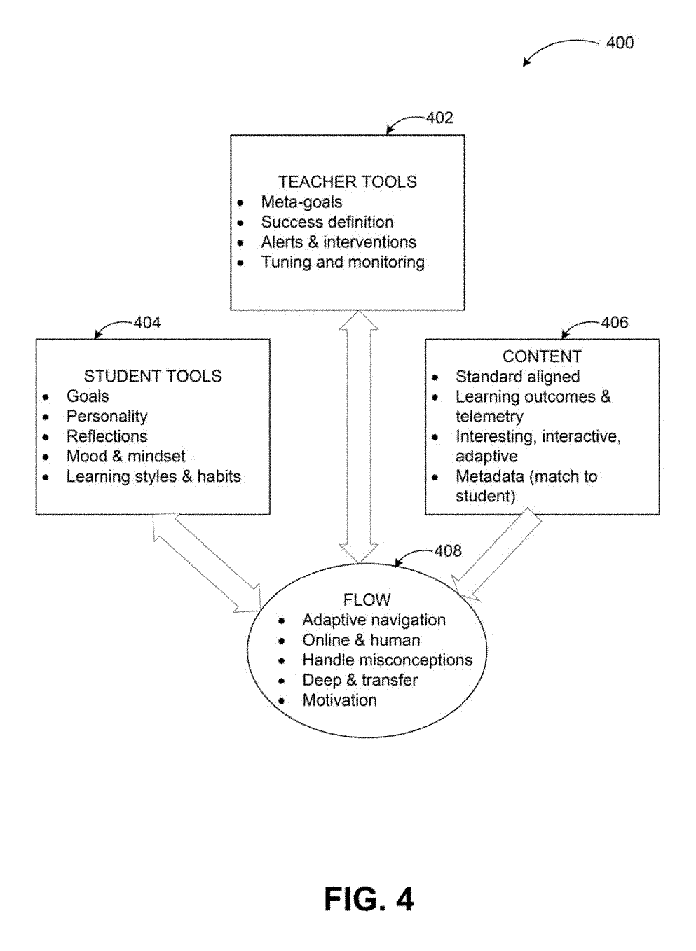

FIG. 4 illustrates conceptually interactions between core elements of an adaptive and personalized learning system employing proactive content recommendation in teaching space according to some embodiments.

Among other things, embodiments are directed to enabling a modern, personalized and adaptive learning experience for different groups of students. Teachers may be supported by freeing their time through optimization of the learning process, creation of easy and simple to use experiences, and provision of actionable analytics and proactive alerts. Large audiences of active students may use the system daily to consume large sets of content while providing the system rich telemetry and learning outcomes. A system according to embodiments may be data driven and self-improving based on the evidence collected. The system may use evidence based approach by using choices based on pass success and collect the evidence when uncertainty exists.

A personalized and adaptive system may be a set of products and features which work together to achieve the desired learning outcomes. At a high level, there may be four core elements: learning content 406, student tools 404, teacher tools 402, and learning flow 408.

### Learning Content

The system may have access to a high number of (e.g., millions) high quality content units. Content may be (a) well aligned with learning standards, (b) immersive, engaging and entertaining, (c) can be elegantly embedded into the student working canvas, (d) provide rich information on learning outcomes and telemetry, (e) contain metadata (either curated or inferred) such as levels of difficulty, matching to learning styles and metacognitive strategies, etc., (f) optionally bundle learning with assessing (‘Active Learning’), and (g) adaptive by itself (i.e., change according to student's pace and progress).

### Student Tools

The system may provide the student with rich tools for (a) setting goals and expectations, (b) expressing her personality (e.g., areas of interest, culture, community, learning styles and habits), (c) expressing her current state and mindset (e.g., recent success and challenges, mood, day-to-day problems she encounters with, reflections), and (d) a portfolio of outstanding deliverables and achievements. These student tools may be related to a ‘student voice’.

### Teacher Tools

The system may provide to the teacher tools to create, manage and monitor the learning flow. The tools may include (a) an ability to add higher level motivations (meta-goals such as improvement of verbal abilities), (b) an ability to adjust student goals, (c) alerts for interventions, (d) an ability to manually tune or override content selection, (e) reports and dashboards, and (f) an ability to define success so the student has a clear picture of the learning outcomes.

### The Learning Flow

The learning flow may bring together the student, teacher, and content into a continuous learning process of clearly defined and discrete tasks while providing the student and teacher with the needed functionality such as setting goals, reflections, alerts, etc. The learning flow may drive from the following themes:

### Adaptive Navigation

Personalizing a student learning path may yield greater learning outcomes. A student may potentially progress in multiple paths and at each point in time use one content which is selected out of many. The variety of options may contribute to the success of the personalized learning. The learning flow may provide the ability to navigate the student to the learning outcome in an optimal way.

### Human Vs. Online Sessions

Learning progress may be achieved either by online sessions or learning from humans who are knowledgeable enough to transfer. Social interaction may be the basis for cognitive growth and peer learning is a success factor. An autonomous learner may be bound to eventually get ‘blocked’ and there may be a need for human interaction to ‘break’ such ‘blocks’.

### Achieving ‘Deep’

The learning flow may aim to push a student to reach deep levels of understanding at the current concepts being learned before progressing too far with new ones.

### Difficulty, Motivation, and Encouragement

A fine balance between difficulty, motivation, and encouragement may be achieved through a system according to embodiments. The learning flow may monitor the student level of engagement and motivation. It may adjust difficulty and increase encouragement when needed with a goal of shortening the elapse time between student experiencing frustration and the teacher awareness.

### Match to Goals, Standards, and Acquired Knowledge

More education systems adhere to a learning ‘standards’ (such as Common Core), which may detail in fine granularity the skills and knowledge a student may need to have at each grade and for each subject. A system according to embodiments may be familiar with the majority of standards and ensure content matches such standards. In addition, the system may consider the prerequisites of each concept (i.e., recommend a new concept when key prerequisites are fulfilled by the student).

### Difficulty

Content difficulty may play a key role in keeping the students engaged (also referred to as Zone of proximal development or Goldilocks Principal). One way to achieve this may be to monitor the current cognitive load the student is experiencing (e.g., via telemetry, explicit feedback, or other signals).

### Efficacy

A system according to embodiments may use collaborative information to estimate content efficacy per student. When measuring efficacy, the following factors may be considered: (a) a potential gain in skill and knowledge the student is expected to have and the alignment of gain to the student goals/teacher meta-goals, (b) a duration needed for the student to learn the concept using the content and the expected student attention span and (c) the elements of fun/engagement embedded into the content.

### Student Profile

Engaging with the student areas of interest, learning styles, and habits may yield greater learning outcomes. The system may use information from the ‘student voice’ to best match content to the student.

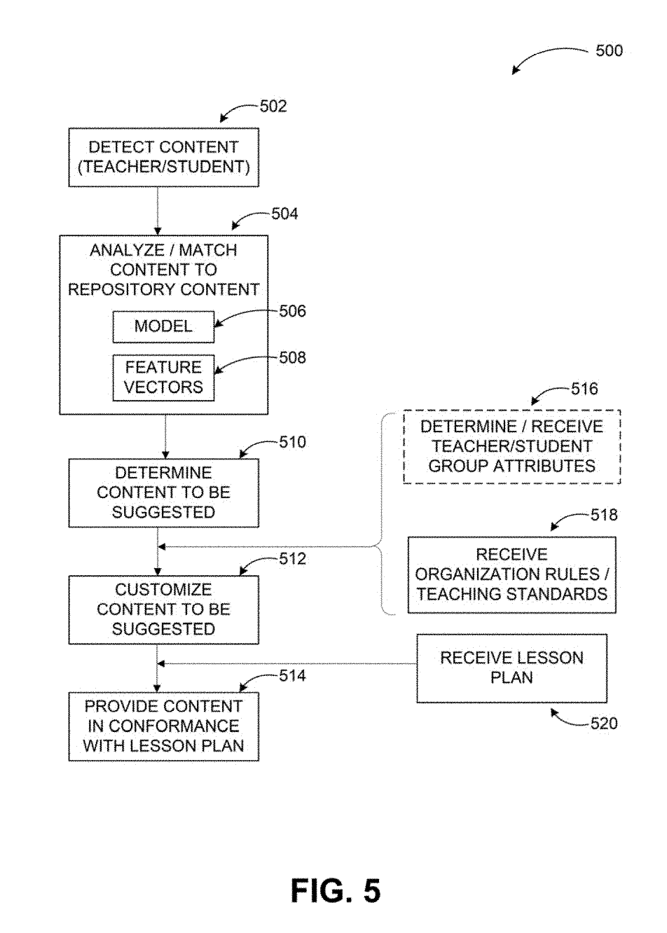

FIG. 5 illustrates a flow of actions in an adaptive and personalized learning system employing proactive content recommendation in teaching space according to some embodiments.

As shown in diagram 500, an example system may begin with detection of teacher or student entered content 502 into a teaching container such as a smart whiteboard, a notebook, a class collaboration site, etc. The detected content 502 may be analyzed and matched 504 to content at a learning object repository. The learning object repository may contain a variety of content units in different formats (e.g., mathematics texts, charts, videos; language texts, interactive objects, images; etc.). A model 506 for the content may be used in the analysis and matching. For example, feature vectors 508 may be generated and compared to feature vectors of learning object repository content.

Content to be suggested (from the learning object repository) may be determined (510) as a result of the analysis and matching. Concurrently or subsequently, teacher and/or student group attributes 516 as discussed previously may be determined or received from a data store. Similarly, organization rules (e.g., school rules) and teaching standards 518 may also be received from another data store. Both group attributes and rules/standards may be employed to customize the content to be suggested 512. The customization may include style, formatting, ‘voice’ matching, and other adaptations. A lesson plan 520 may also be received and the customized content may be conformed to the lesson plan 514. The conformance may include a timeline insertion, a presentation format adaptation, or other modifications.

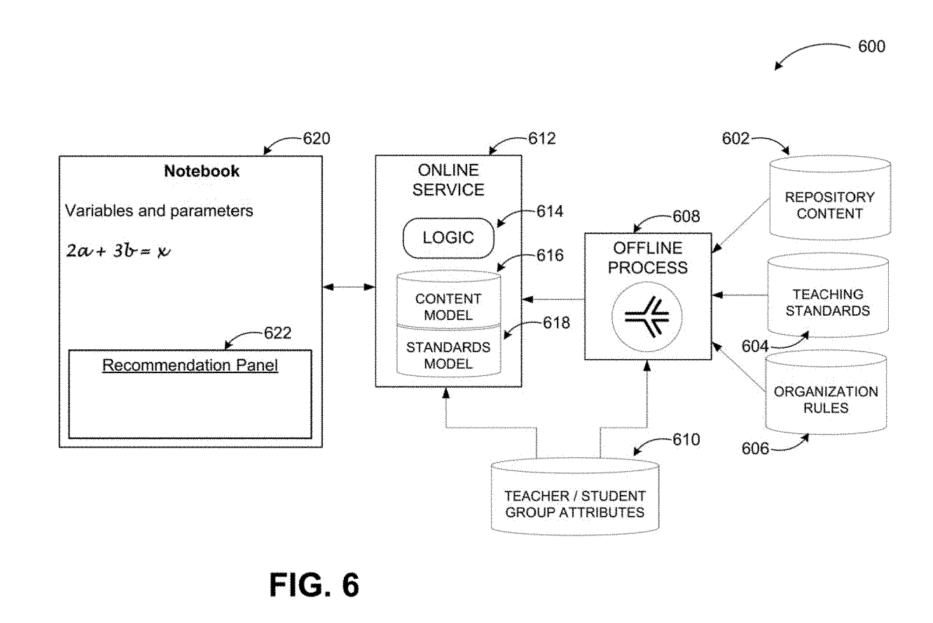

FIG. 6 illustrates conceptually an example system for proactive content recommendation in teaching space and actions associated with the flow of operations according to some embodiments.

In the example system shown in diagram 600, entries in a notebook 620 maintained by a notebook application may be detected and processed by logic 614 (processing circuits) of an online service 612 such as teaching service 116 in FIG. 1. An offline machine learning or artificial intelligence process 608 may receive repository content 602, teaching standards 604, and organization rules 606. The offline machine learning or artificial intelligence process 608 may also receive teacher and/or student group attributes 610 to select content to be suggested for incorporation into a lesson plan, for example.

The online service 612 may also receive the teacher and/or student group attributes 610 to customize the selected content front the learning object repository. The online service 612 may use a content model 616 and a standards model 618 to further select and customize the content to be provided to the notebook 620 in some example implementations. The customized content may be presented in a recommendation panel 622 for manual incorporation into the lesson plan or may be automatically incorporated into the lesson plan.

In some scenarios, a tide or an initial description of an entry in the notebook 620 may provide sufficient information to infer content of a lesson and determine content to be suggested from a learning object repository. In other examples, the information may be harder to retrieve. For example, textual entries (typed or ink) may not be clear, the entry may contain images or audio data, etc. However, there may be a number of hints to assist the analysis and comparison. For example, the repository may include metadata on standards and available content associated with connections between those two, a few words in the entered content may be informative, context of the entire notebook (e.g., previous and/or subsequent pages) may be informative, data available through one or more applications associated with the teacher and/or students such as schedule may be helpful, and other teacher's information from similar classes may provide insight into what kind of content may be suggested.

According to some embodiments, the suggested content may be determined based on a confidence determination. If the confidence level is above a predefined threshold, the determined content from the repository may be suggested. The confidence threshold may be adjusted based on usage and results by the teacher, students, and other teachers.

In some examples, a text based similarity algorithm may be employed to perform the comparison between the entered content and available content from the learning object repository. Such an algorithm may compute feature weights based on wording frequencies (non-textual content may first be converted to text). Feature vectors may then be created for each content and standard at the repository (e.g. leaf level). The algorithm may also make use of n-grams (sequence of words). Furthermore, similarity be available content may also be used to determine additional content.

For each content unit in the learning object repository, content description and descriptions of standards (e.g., Common Core standards) pointing to the content may be used. In further embodiments, usage based collaborative filtering may be employed based on the repository usage, images may be analyzed through optical character recognition and mapped to a standard via video frames, etc.

In other examples, a set of tools may be provided to be displayed for the teacher/student to interact with the lesson plan and to further customize the suggested content. The set of tools may be configured to enable a student to one or more of set goals, express a personality, express a current mindset, and track achievements associated with the lesson plan. The set of tools may also be configured to enable a teacher to create, manage, and monitor a learning flow of the lesson plan by adding motivations, adjusting student goals, creating alerts for interventions, manually tuning or overriding content selection, creating reports and dashboards, and define success.

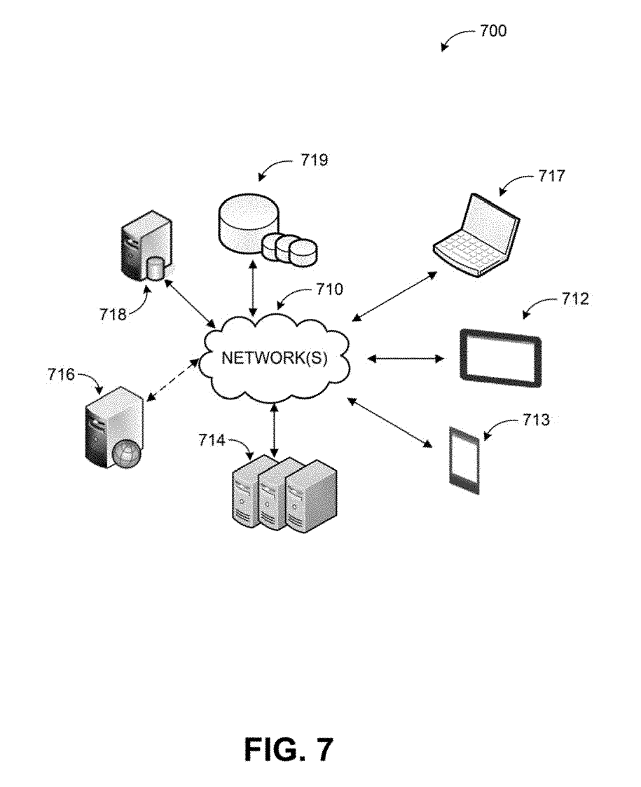

FIG. 7 is an example networked environment, arranged in accordance with at least some embodiments described herein.

As shown in a diagram 700, a cloud based service providing proactive content recommendation in teaching space may be implemented in a networked environment over one or more networks such as network 710. An example of the cloud based service may include a storage service managing and/or storing content (such as document(s)). Users may access the cloud based service through locally installed or thin (e.g., browser) client applications executed on a variety of computing devices. Functionality within the cloud based service environment may be provided by a teaching module or application executed within the cloud based service executed on servers 714 or processing server 716.

A cloud based service, as discussed herein, may be implemented via software executed over servers 714. The servers 714, may include one or more processing server 716, where at least one of the one or more processing servers 716 may be configured to execute one or more applications associated with the cloud based service. The cloud based service may store data associated with user action(s), user(s), and/or content in a data store 719 directly or through a database server 718.

The network 710 may comprise any topology of servers, clients, Internet service providers, and communication media. A system according to embodiments may have a static or dynamic topology. The network 710 may include multiple secure networks, such as an enterprise network, an unsecure network, or the Internet. The unsecure network may include a wireless open network. The network 710 may also coordinate communication over other networks, such as Public Switched Telephone Network (PSTN) or cellular networks. Furthermore, the network 710 may include multiple short-range wireless networks, such as Bluetooth, or similar ones. The network 710 may provide communication between the nodes described herein. By way of example, and not limitation, the network 710 may include wireless media. The wireless media may include, among others, acoustic media, RF media, infrared media, and other wireless media.

A textual scheme, a graphical scheme, an audio scheme, an animation scheme, a coloring scheme, a highlighting scheme, and/or a shading scheme may be employed to further enhance user interaction with a client interface of the cloud based service that provides proactive content recommendation in teaching space.

Many other configurations of the computing devices, the applications, the data sources, and the data distribution systems may be employed to provide proactive content recommendation in teaching space. Furthermore, the networked environments discussed in FIG. 7 are for illustration purposes only. Embodiments are not limited to the example applications, modules, or processes.

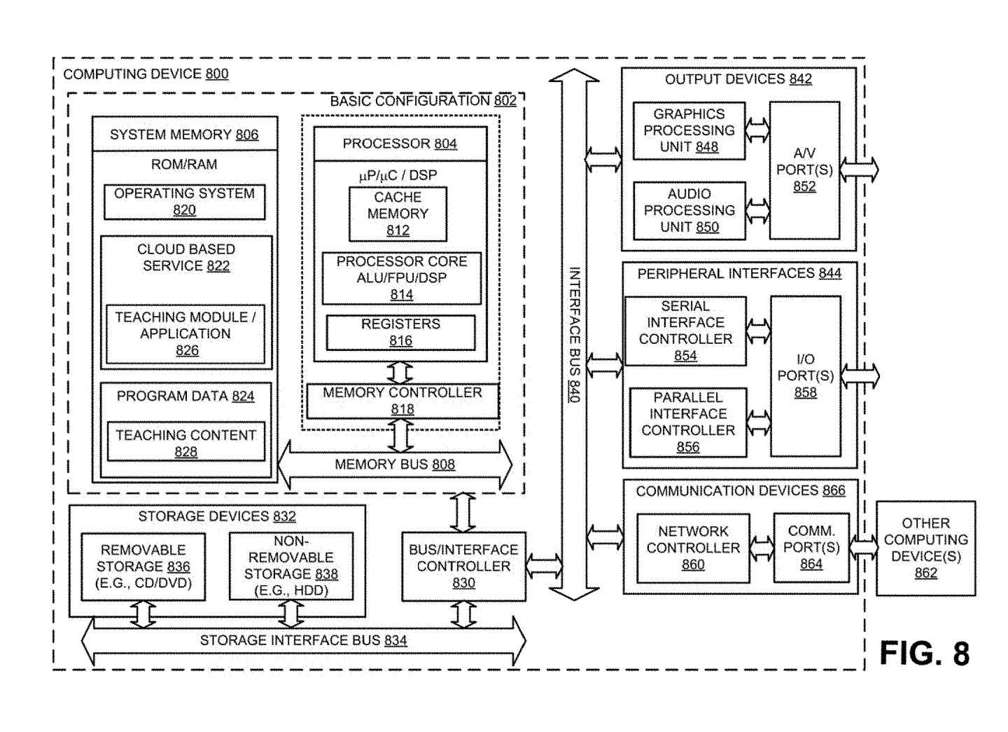

FIG. 8 illustrates a computing device, which may be configured to provide proactive content recommendation in teaching space, arranged in accordance with at least some embodiments described herein.

For example, a computing device 800 may be a server used to provide proactive content recommendation in teaching space within a hosted service such as a cloud based service 822, as discussed herein. In an example of a basic configuration 802, the computing device 800 may include a processor 804 and a system memory 806. The processor 804 may include multiple processors. A memory bus 808 may be used for communication between the processor 804 and the system memory 806. The basic configuration 802 may be illustrated in FIG. 8 by those components within the inner dashed line.

Depending on the desired configuration, the processor 804 may be of any type, including, but not limited to, microprocessor (μP), a microcontroller (μC), a digital signal processor (DSP), or any combination thereof. The processor 804 may include one more levels of caching, such as a level cache memory 812, a processor core 814, and registers 816. The processor core 814 may include an arithmetic logic unit (ALU), a floating point unit (FPU), a digital signal processing core (DSP Core), or any combination thereof. A memory controller 818 may also be used with the processor 804, or in some implementations, the memory controller 818 may be an internal part of the processor 804.

Depending on the desired configuration, the system memory 806 may be of any type including but not limited to volatile memory (such as RAM), non-volatile memory (such as ROM, flash memory, etc.), or any combination thereof. The system memory 806 may include an operating system 820, the cloud based service 822, and program data 824. The cloud based service 822 may include a teaching module or application 826. The teaching module or application 826 may initiate operations by detecting entry of content in a teaching data container and analyzing the content. Base on the analysis and other factors associated with the teaching environment, content may be selected from a learning object repository and suggested to a teacher and/or students.

In an example scenario, the cloud based service may be a productivity service and the teaching module or application 826 may work in conjunction with document processing application(s) such as a notebook application, which stores/manages teaching content, initial action may be uploading of a file. Program data 824 may include, among others, teaching data 828.

The computing device 800 may have additional features or functionality, and additional interfaces to facilitate communications between the basic configuration 802 and any desired devices and interfaces. For example, a bus/interface controller 830 may be used to facilitate communications between the basic configuration 802 and data storage devices 832 via a storage interface bus 834. The data storage devices 832 may be removable storage devices 836, non-removable storage devices 838, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 806, the removable storage devices 836, and the non-removable storage devices 838 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (for example, one or more output devices 842, one or more peripheral interfaces 844, and one or more communication devices 866) to the basic configuration 802 via the bus/interface controller 830. The one or more output devices 842 may include a graphics processing unit 848 and an audio processing unit 850, which may be configured to communicate to various external devices, such as a display or speakers via one or more A/V ports 852. The one or more peripheral interfaces 844 may include a serial interface controller 854 or a parallel interface controller 856, which may be configured to communicate with external devices, such as input devices (for example, keyboard, mouse, pen, voice input device, touch input device, etc.) or other peripheral devices (for example, printer, scanner, etc.) via one or more I/O ports 858. The one or more communication devices 866 may include a network controller 860, which may be arranged to facilitate communications with one or more other computing devices 862 over a network communication link via one or more communication ports 864. The one or more other computing devices 862 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 800 may be implemented as a part of a general purpose or specialized server, mainframe, or similar computer, which includes any of the above functions. The computing device 800 may also be implemented as a personal computer including both laptop computer and non-laptop computer configurations.

Example embodiments may also include methods to provide proactive content recommendation in teaching space. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

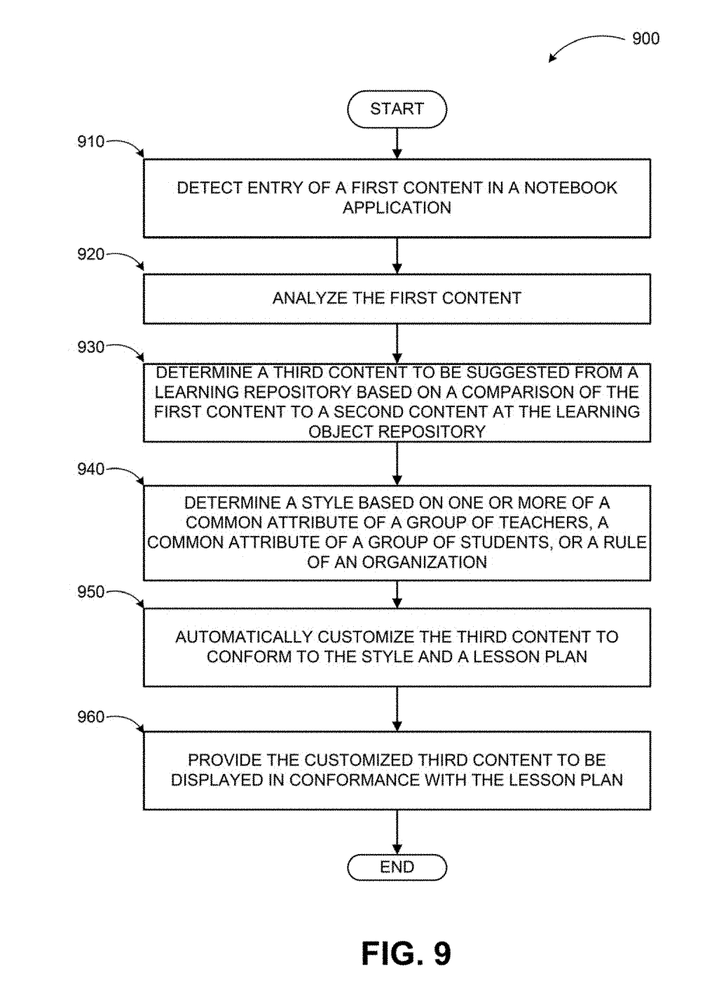

FIG. 9 illustrates a logic flow diagram for an example process to provide proactive content recommendation in teaching space, arranged in accordance with at least some embodiments described herein.

A process 900 may be implemented by a cloud based service and/or its components, for example by a teaching module of the cloud based service, where the components may be executed on one or more servers or other computing devices.

Process 900 may begin with operation 910, where entry of content in a teaching data container by a teacher or a student may be detected. For example, the teaching data container may be a notebook of a notebook application that stores and manages content of various types such as documents, audio content, video content, ink entries, and many more. Thus, the detected entry of the content in the notebook may be ink entry by a teacher or pasted content from another source. At operation 920, the entered content may be analyzed. A first set of feature vectors may be generated based on the analysis.

At operation 930, the first set of feature vectors mays be compared to a second set of feature vectors associated with content from a learning object repository. The content in the learning object repository may include a wide range of content including, but not limited to documents, audio objects, video objects, interactive material, and comparable ones. The second set of feature vectors may be generated from the content in the learning object repository or received as generated feature vectors. Based on the comparison content to be suggested from the learning object repository may be determined.

At operation 940, a style may be determined based group or individual attributes of a teacher (or teachers) and/or a student (or students), as well as, a rule of an organization (e.g., a school). At operation 950, the suggested content may be customized automatically to conform to the determined style and a lesson plan. The customized content may then be provided to be displayed in conformance with the lesson plan at operation 960. In presenting the customized content a spectrum of options may be employed. For example, the customized content may be provided as a simple list (or with previews) for the teacher and/or students to manually incorporate to the lesson materials. In another example, the teacher's lesson presentation style may be learned from direct input or analysis of teacher's history and the customized content may be combined according to the teacher's lesson presentation style. Other teachers' styles, default rules of a school or similar organization may also be used to adjust the style.

The operations included in process 900 are for illustration purposes. A cloud based service to provide proactive content recommendation in teaching space, according to embodiments, may be implemented by similar processes with fewer or additional steps, as well as in different order of operations using the principles described herein.

According to examples, a means for providing proactive content recommendation in a teaching space is described. The means may include a means for analyzing the first content upon detecting entry of a first content in a notebook application; a means for determining a third content to be suggested from a learning object repository based on a comparison of the first content to a second content at the learning object repository, where the third content is at least a subset of the second content; a means for determining a style based on one or more of a common attribute of a group of teachers, a common attribute of a group of students, or a rule of an organization; a means for automatically customizing the third content to conform to the style and a lesson plan; and a means for providing the customized third content to be displayed in conformance with the lesson plan.

According to sonic examples, a method to provide proactive content recommendation in a teaching space is described. The method may include upon detecting entry of a first content in a notebook application, analyzing the first content; determining a third content to be suggested from a learning object repository based on a comparison of the first content to a second content at the learning object repository, where the third content is at least a subset of the second content; determining a style based on one or more of a common attribute of a group of teachers, a common attribute of a group of students, or a rule of an organization; automatically customizing the third content to conform to the style and a lesson plan; and providing the customized third content to be displayed in conformance with the lesson plan.

According to other examples, determining the third content to be suggested from the learning object repository may include generating a first set of feature vectors from the first content based on the analysis; and comparing the first set of feature vectors to a second set of feature vectors associated with the second content from the learning object repository. The common attribute of the group of teachers may include one or more of a content selection preference, a formatting preference, a content structure preference, and a presentation preference. The common attribute of the group of students may include one or more of a learning ability, a learning disability, an interest in a particular content, an interest in a particular content structure, a formatting preference, and a presentation preference. The method may also include receiving the common attribute of the group of teachers, the common attribute of the group of students, or the rule of the organization from an organization data store.

According to further examples, the method may further include obtaining the common attribute of the group of teachers or the common attribute of the group of students from one or more of a usage history, a survey, and an analysis of other groups. The method may also include applying the rule of the organization to one of preempt and supersede the common attribute of the group of teachers or the common attribute of the group of students in determining the style. Providing the customized third content to be displayed may include providing the third content through the notebook application, in which the first content is detected. Providing the customized third content to be displayed may also include providing the third content as part of a none-notebook file to be incorporated into the notebook application, in which the first content is detected. The none-notebook file may include a presentation document, a word processing document, a video file, an audio file, or an interactive object.

According to other examples, a server configured to provide proactive content recommendation in teaching space is described. The server may include a communication interface configured to facilitate communication between a client device and the server; a memory configured to store instructions; one or more processors coupled to the memory. The one or more processors, in conjunction with the instructions stored in the memory, may execute teaching module of a hosted service. The teaching module may be configured to analyze the first content upon detecting entry of a first content in a teaching container by one of a teacher and a student; determine a third content to be suggested from a learning object repository based on a comparison of the first content to a second content at the learning object repository, where the third content is at least a subset of the second content; obtain a common attribute of the group of teachers and a common attribute of the group of students from one or more of a usage history, a survey, and an analysis of other groups; determine a style based on one or more of the common attribute of a group of teachers, the common attribute of a group of students, or a rule of an organization; automatically customize the third content to conform to the style and a lesson plan; and provide the customized third content to be displayed in conformance with the lesson plan.

According to some examples, the teaching module may be further configured to provide a set of tools to be displayed for one or both of the teacher and the student to interact with the lesson plan and to further customize the third content. The set of tools may be configured to enable the student to one or more of set a goal, express a personality, express a current mindset, and track an achievement associated with the lesson plan. The set of tools may also be configured to enable the teacher to one or more of create, manage, and monitor a learning flow of the lesson plan by one or more of adding a motivation, adjusting a student goal, creating an alert for an intervention, manually tuning or overriding a content selection, and defining a success parameter. The teaching module may be configured to one or both of determine the third content to be suggested and obtain the common attribute of the group of teachers and the common attribute of the group of students through an offline process employing one or more of machine learning and artificial intelligence. The lesson plan may be arranged to provide one or more of a timeline definition for lesson presentation, a rule for selection of the third content, and a rule for the style. The teaching container may be a notebook managed by a notebook application, an online collaboration site, or a whiteboard capable of capturing content.

According to further examples, a system configured to provide proactive content recommendation in teaching space is described. The system may include a first server configured to execute a productivity service with a plurality of productivity application components; a second server configured to manage a learning object repository; and a third server configured to execute a teaching service. The third server may include a communication interface configured to facilitate communication between the first server, the second server, the third server, and a client device; a memory configured to store instructions; one or more processors coupled to the memory, where the one or more processors, in conjunction with the instructions stored in the memory, execute the teaching service. The one or more processors may detect an entry of a first content in a teaching container by one of a teacher and a student, analyze the first content; determine a third content to be suggested from a learning object repository based on a comparison of the first content to a second content at the learning of repository, where the third content is at least a subset of the second content; obtain a common attribute of the group of teachers and a common attribute of the group of students from one or more of a usage history, a survey, and an analysis of other groups; determine a style based on one or more of the common attribute of a group of teachers, the common attribute of a group of students, or a rule of an organization; automatically customize the third content to conform to the style and a lesson plan; and provide the customized third content to be displayed to the client device in conformance with the lesson plan.

According to yet other examples, the teaching service may be configured to provide a report and a dashboard to be displayed to the client device based on monitoring a learning flow of the lesson plan. The teaching service may also be configured to create a content model for selection and customization of the third content.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of devices and users activating client applications for hosted services.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide proactive content recommendation in a teaching space, the method comprising:
upon detecting entry of a first content in a notebook application, analyzing the first content;
determining a third content to be suggested from a learning object repository based on a comparison of the first content to a second content at the learning object repository, wherein the third content is at least a subset of the second content;
determining a style based on one or more of a common attribute of a group of teachers, a common attribute of a group of students, or a ride of an organization;
automatically customizing the third content to conform to the style and a lesson plan; and
providing the customized third content to be displayed in conformance with the lesson plan.

2. The method of claim 1, wherein determining the third content to be suggested from the learning object repository comprises:
generating a first set of feature vectors from the first content based on the analysis; and
comparing the first set of feature vectors to a second set of feature vectors associated with the second content from the learning object repository.

3. The method of claim 1, wherein the common attribute of the group of teachers includes one or more of a content selection preference, a formatting preference, a content structure preference, and a presentation preference.

4. The method of claim 1, wherein the common attribute of the group of students includes one or more of a learning ability, a learning disability, an interest in a particular content, an interest in a particular content structure, a formatting preference, and a presentation preference.

5. The method of claim 1, further comprising:
receiving the common attribute of the group of teachers, the common attribute of the group of students, or the rule of the organization from an organization data store.

6. The method of claim 1, further comprising:
obtaining the common attribute of the group of teachers or the common attribute of the group of students from one or more of a usage history, a survey, and an analysis of other groups.

7. The method of claim 1, further comprising:
applying the rule of the organization to one of preempt and supersede the common attribute of the group of teachers or the common attribute of the group of students in determining the style.

8. The method of claim 1, wherein providing the customized third content to be displayed comprises:
providing the third content through the notebook application, in which the first content is detected.

9. The method of claim 1, wherein providing the customized third content to be displayed comprises:
providing the third content as part of a none-notebook file to be incorporated into the notebook application, in which the first content is detected.

10. The method of claim 9, wherein the none-notebook file includes one of: a presentation document, a word processing document, a video file, an audio file, and an interactive object.

11. A server configured to provide proactive content recommendation in teaching space, the server comprising:
a communication interface configured to facilitate communication between a client device and the server;
a memory configured to store instructions;
one or more processors coupled to the memory, wherein the one or more processors, in conjunction with the instructions stored in the memory, execute teaching module of a hosted service, the teaching module configured to:
upon detecting entry of a first content in a teaching container by one of a teacher and a student, analyze the first content;
determine a third content to be suggested from a learning object repository based on as comparison of the first content to a second content at the learning object repository, wherein the third content is at least a subset of the second content;
obtain a common attribute of the group of teachers and a common attribute of the group of students from one or more of a usage history, a survey, and an analysis of other groups;
determine a style based on one or more of the common attribute of a group of teachers, the common attribute of a group of students, or a rule of an organization;
automatically customize the third content to conform to the style and a lesson plan; and
provide the customized third content to be displayed in conformance with the lesson plan.

12. The server of claim 11, wherein the teaching module is further configured to provide a set of tools to be displayed for one or both of the teacher and the student to interact with the lesson plan and to further customize the third content.

13. The server of claim 12, wherein the set of tools are configured to enable the student to one or more of set a goal, express a personality, express a current mindset, and track an achievement associated with the lesson plan.

14. The server of claim 12, wherein the set of tools are configured to enable the teacher to one or more of create, manage, and monitor a learning flow of the lesson plan by one or more of adding a motivation, adjusting a student goal, creating an alert for an intervention, manually tuning or overriding a content selection, and defining a success parameter.

15. The server of claim 11, wherein the teaching module is configured to one or both of determine the third content to be suggested and obtain the common attribute of the group of teachers and the common attribute of the group of students through an offline process employing one or more of machine learning and artificial intelligence.

16. The server of claim 11, wherein the lesson plan is arranged to provide one or more of a timeline definition for lesson presentation, a rule for selection of the third content, and a rule for the style.

17. The server of claim 11, wherein the teaching container is one of a notebook managed by a notebook application, an online collaboration site, and a whiteboard capable of capturing content.

18. A system configured to provide proactive content recommendation in teaching space, the system comprising:
a first server configured to execute a productivity service with a plurality of productivity application components;
a second server configured to manage a learning object repository; and
a third server configured to execute a teaching service, the third server comprising:
a communication interface configured to facilitate communication between the first server, the second server, the third server, and a client device;
a memory configured to store instructions;
one or more processors coupled to the memory, wherein the one or more processors, in conjunction with the instructions stored in the memory, execute the teaching service, the one or more processors configured to:
detect an entry of a first content in a teaching container by one of a teacher and a student;
analyze the first content;
determine a third content to be suggested from a learning object repository based on a comparison of the first content to a second content at the learning object repository, wherein the third content is at least a subset of the second content;
obtain a common attribute of the group of teachers and a common attribute of the group of students from one or more of a usage history, a survey, and an analysis of other groups;
determine a style based on one or more of the common attribute of a group of teachers, the common attribute of a group of students, or a rule of an organization;
automatically customize the third content to conform to the style and a lesson plan; and
provide the customized third content to be displayed to the client device in conformance with the lesson plan.

19. The system of claim 18, wherein the teaching service is configured to provide a report and a dashboard to be displayed to the client device based on monitoring a learning flow of the lesson plan.

20. The system of claim 18, wherein the teaching service is configured to create a content model for selection and customization of the third content.
